(19) United States
(12) Patent Application Publication
(10) Pub. No.: US 2006/0165513 A1
(43) Pub. Date: Jul. 27, 2006

(54) Inspection system for rolled products of a milling station

(76) Inventors: Bernd Tiepelmann, Hilchenbach (DE); Horst Oemkes, Oberhausen (DE)

Correspondence Address: FRIEDRICH KUEFFNER, 317 MADISON AVENUE, SUITE 910, NEW YORK, NY, 10017, US

(21) Appl. No.: 10/544,604

(22) PCT Filed: Jan. 30, 2004
(86) PCT No.: PCT/EP04/00834

§ 371 Date: Mar. 20, 2006

(30) Foreign Application Priority Data
Feb. 5, 2003 (DE) 10304581.3

(51) Int. Cl. B65G 47/22; B65G 47/24

(52) U.S. Cl. 414/759; 198/403

(57) ABSTRACT

The aim of the invention is to create an inspection system (1) for rolled products (2) of a milling station, which allows an examiner to examine both sides of the rolled products (2) at an ergonomically convenient height. Said aim is achieved by providing the inspection system (1) with a turning device (10) in which two receiving elements (12, 14) for rolled products (2) can be pivoted about a rotating pin (16) that is aligned essentially parallel to the plane of extension of the rolled products (2).

The invention concerns an inspection system for the rolled products of a rolling mill, in which a turning device is positioned upstream of a number of inspection tables, with respect to the direction of conveyance of the rolled products.

In order to subject the rolled products to an inspection for possible defects formed during the rolling operation, inspection stations are installed downstream of the rolling process, from which an inspector can inspect the upper surface of the rolled products. To allow inspection of the underside, the rolled product can be turned over after the first inspection table by means of a turning device, for example, a so-called turning roll, and thus conveyed onto a lower inspection table located below the first inspection table in order to expose the underside of the rolled product. This inspection of the rolled product on the lower table can make it necessary for the inspector to assume a stooped or kneeling position, and this can possibly have negative health consequences in the long term. Therefore, in order to preserve the health of workers, the consideration of ergonomic factors is becoming an increasingly important aspect of workplace design.

Therefore, the objective of the invention is to specify an inspection system for the rolled products of a rolling mill of the type specified above, which allows an inspector to inspect both sides of the rolled product at an ergonomically favorable height.

In accordance with the invention, this objective is achieved by providing the inspection system with a turning device, in which two receiving elements for rolled products can be rotated about an axis of rotation that is aligned essentially parallel to the plane of extension of the rolled products.

The invention is based on the consideration that it is ergonomically disadvantageous, i.e., in the present case, it is a disadvantage with respect to the performance capability of the inspector and with respect to optimum working conditions for the inspector, to perform the inspection of the rolled products on two planes. Therefore, the inspection system was to be designed to allow inspection of both the upper side of the rolled product and, after a 180° turn of the rolled product, the underside of the rolled product on one working plane, i.e., to keep the same working plane for both positions of the rolled product. This can be accomplished by means of a suitably designed turning device. For this purpose, the turning device for the ergonomically favorable inspection of the upper side and the underside of the rolled product on one and the same plane is equipped with two receiving elements for rolled products. These two receiving elements can be rotated about an axis of rotation that is aligned essentially parallel to the plane of extension of the rolled products.

To take into account the usually limited amount of space for an inspection system, it is advantageous to keep the range of rotation of the receiving element as small as possible. This can be achieved in an advantageous way by orienting the axis of rotation of the receiving element in the direction of conveyance of the rolled products.

To maintain the working plane that is ergonomically favorable for the inspector even after a 180° turn of the rolled products, the receiving elements are preferably arranged with mirror symmetry parallel to the axis of rotation.

Belt conveyors are effective for conveying the rolled products, for example, in the direction of the inspection tables. In addition, to allow level further conveyance of the rolled products, for example, in the direction of the downstream inspection tables, even after a 180° turn, each receiving element preferably comprises at least one pair of belt conveyors that lie in two planes for the common conveyance of a rolled product positioned between them, for which purpose the belt conveyors that form a pair advantageously have opposite directions of rotation and the same direction of conveyance of the rolled product. The given rolled product can thus be further conveyed at the given height of the lower belt conveyor that lies in the given inspection plane directly onto a downstream inspection table that lies in the same plane.

To avoid possible slipping of the rolled product between the belt conveyors of the given receiving element, especially during the turning operation, the belt conveyors are preferably provided with a number of fixing devices for the rolled products.

To allow simple handling, for example, by remote control, it is especially advantageous to design the fixing devices for the rolled products as magnets, preferably electromagnets.

To allow organizational and logistic disconnection of the operating sequences, a temporary storage system for the rolled products is provided upstream of the turning device. After they have been produced, the rolled products can be parked in this temporary storage system until the surface inspection is to be performed. In an especially advantageous design, the temporary storage system for the rolled products is a belt conveyor for the rolled products which can be intermittently stopped as required.

A specific embodiment of the invention is explained in greater detail below with reference to the drawings.

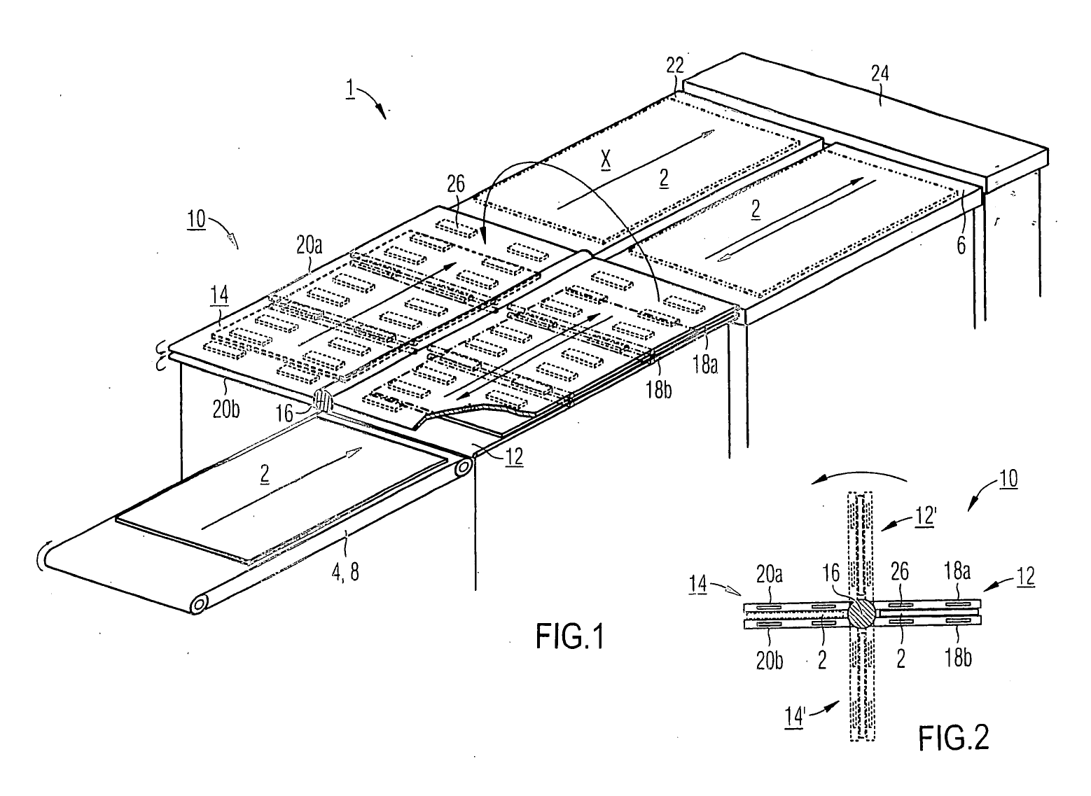

FIG. 1 shows a schematic top view of an inspection system for rolled products of a rolling mill.

FIG. 2 shows a schematic side view of a turning device transverse to the direction of conveyance of the rolled products.

The same parts in the two drawings are labeled with the same reference numbers.

An inspection system 1 comprises an entry section (not shown here), in which the rolled products 2 to be inspected, such as sheet panels, are cut out directly from the continuous production of the rolling operation, for example, by means of rotary shears (not shown), from a strip of rolled product that has been rolled to its final thickness, and in which the rolled products 2 are then conveyed by conveying equipment, especially a belt conveyor 4, to a downstream inspection table 6.

In the present embodiment, the belt conveyor 4 is also designed to serve as a temporary storage system 8 for the rolled product. This means that the belt conveyor 4 can be stopped as required and can act as a parking station for the rolled products 2 in order, for example, to prevent excessively fast continued conveyance of rolled products 2 to be inspected and thus to ensure trouble-free operation between the rolling production and the inspection of the rolled products. The temporary storage system 8 for the rolled products thus serves as a buffer.

When a rolled product 2 is released for further conveyance, it is conveyed onto a downstream inspection table 6, where an inspector inspects the surface of the rolled product 2 that rests on the inspection table 6 for defects that may have developed during the rolling process. This occurs at a time that is still relatively close to the time of production. As a result, this in-line inspection is able to detect surface defects of the rolled product 2, while the rolled product is still in a rolling installation.

To allow inspection of not only the upper side but also the underside of the rolled product 2, the rolled product 2 in question must be turned, usually by 180°. A so-called turning roll (not shown) is often used for this purpose. In this regard, the rolled product 2 can be guided over this roll from a first inspection table to a lower inspection table located below the first inspection table in order to expose the underside of the rolled product 2 by this 180° turn. The plane lying below the inspection plane of the upper side thus makes the inspection of the underside of the rolled product 2 difficult for the inspector, since he is forced to assume a stooped and thus uncomfortable posture if, for example, the rolled product is on the floor, or since he may possibly have to climb down, e.g., a set of stairs, to reach the lower plane. Therefore, it is desirable, especially for ergonomic reasons, to have a device which turns a rolled product 2 in such a way that the underside thereby exposed lies directly, without any further intermediate steps, at the same ergonomically favorably selected height for the inspector as the previously inspected upper side.

To avoid this height difference of the rolled product 2 before and after the 180° turn and the unfavorable effects on the inspector that are associated with this height difference, the inspection system 1 is provided with a turning device 10, in which two receiving elements 12, 14 for rolled products 2 can be rotated about an axis of rotation 16 that is aligned essentially parallel to the plane of extension or working plane X of the rolled products 2, as is shown especially in FIG. 2.

The inspection system 1 is designed by means of the receiving element 12 of the turning device 10 to allow the inspection of both the upper side of the rolled product 2 and, after a 180° turn, the underside of the rolled product 2 on one and the same ergonomically favorable working plane.

In a further refinement, the axis of rotation 16 of the receiving elements 12, 14 in the present embodiment is oriented in the direction of conveyance of the rolled products 2, as shown by the arrow in FIG. 1 and FIG. 2. This refinement of the invention is especially space-saving compared to a possible orientation of an axis of rotation perpendicular to the direction of conveyance.

Furthermore, the receiving elements 12, 14 are arranged with mirror symmetry parallel to the axis of rotation 16. The turning device 10 is thus similar in appearance to a two-blade windmill, as FIG. 2 shows. As a result of the mirror-symmetrical arrangement of the receiving elements 12, 14 relative to the axis of rotation 16, the surface of the rolled products 2 that is to be inspected again lies in the same working plane X that is ergonomically favorable for the inspector after a 180° turn as before the rotation.

In the present embodiment, a pair of belt conveyors 18a,b that lies in two planes is assigned to the receiving element 12 for rolled products 2, while a pair of belt conveyors 20a,b that lies in two planes is assigned to the receiving element 14. Each pair of belt conveyors 18a,b and 20a,b can convey a rolled product 2 positioned inside a pair towards or away from the inspection tables 6 and 22 by an opposite direction of rotation of belt conveyor 18a and belt conveyor 18b and by an opposite direction of rotation of belt conveyor 20a and belt conveyor 20b.

For example, a rolled product 2 guided by the belt conveyor 4 in the direction of inspection table 6 can be conveyed by the belt conveyors 18a,b to inspection table 6, where the upper side of the rolled product can be inspected for production defects by an inspector in the ergonomically favorable working plane X. In the illustrated embodiment, the rolled product 2 whose upper side has been inspected can then be sent for scrapping in a scrapping installation 24, for example, by conveying it further without a change in direction, or it can be conveyed back to the turning device 10 by changing the direction of rotation of the belt conveyors 18a,b. When the rolled product 2 has been returned to the turning device 10 and has been suitably positioned between the belt conveyors 18a,b, the belt conveyor drive (not shown) can be stopped, and the 180° turn about the axis of rotation 16 can be carried out, as indicated in FIGS. 1 and 2 by the arrows. Accordingly, the belt conveyor 18a, which was positioned above the rolled product 2 before the 180° turn, is now positioned below the rolled product 2. The rolled product 2 can then be conveyed on the same plane with its underside directed upward onto the inspection table 22 without having to overcome a height difference by turning on the belt conveyor drive, and the underside of the rolled product can then be inspected for surface defects.

In a further refinement, the belt conveyors 18a,b and 20a,b of the illustrated embodiment are provided with a number of fixing devices 26 for the rolled products 2 in order to avoid possible slipping of the rolled products 2 between the belt conveyors 18a,b or 20a,b of the receiving element 12 or 14, respectively, especially during the turning operation, as indicated in FIG. 2 by the broken-line drawing of the receiving elements 12′, 14′ in the vertical position. The fixing devices 26 in the illustrated embodiment are rectangularly shaped magnets, preferably electromagnets, so that remote control is also possible.

After the inspection of the surfaces has been completed, the inspected rolled product 2 is further conveyed in the conveyance direction to the scrapping installation 24 in this embodiment. Naturally, other types of further processing are also possible.

### LIST OF REFERENCE NUMBERS

1. inspection system
2 rolled product
4 belt conveyor
6 inspection table
8 temporary storage system for rolled product
10 turning device
12, 12′ receiving element
14, 14′ receiving element
16 axis of rotation
18a belt conveyor
18b belt conveyor
20a belt conveyor
20b belt conveyor
22 inspection table
24 scrapping installation
26 fixing devices
X plane of extension or working plane

1. Inspection system (1) for the rolled products (2) of a rolling mill, wherein a turning device (10) is positioned upstream of a number of inspection tables (6, 22) with respect to the direction of conveyance of the rolled products (2), wherein the turning device (10) has two opposite receiving elements (12, 14) for rolled products (2), and wherein the receiving elements (12, 14) can be rotated about an axis of rotation (16) that is aligned essentially parallel to the plane of extension X of the rolled products (2).

2. Inspection system (1) in accordance with claim 1, in which the axis of rotation (16) of the receiving elements (12, 14) is oriented in the direction of conveyance of the rolled products (2).

3. Inspection system (1) in accordance with claim 1, in which the receiving elements (12, 14) are arranged with mirror symmetry parallel to the axis of rotation (16).

4. Inspection system (1) in accordance with claim 1, in which each receiving element (12; 14) comprises at least one pair of belt conveyors (18a,b; 20a,b) that lie in two planes and have opposite directions of rotation and the same direction of conveyance of the rolled products (2).

5. Inspection system (1) in accordance with claim 4, in which the belt conveyors (18a,b; 20a,b) are provided with a number of fixing devices (26) for rolled products (2).

6. Inspection system (1) in accordance with claim 5, in which the fixing devices (26) for rolled products (2) are designed as magnets.

7. Inspection system (1) in accordance with claim 1, in which a temporary storage system (8) for rolled products is provided upstream of the turning device (10).

8. Inspection system (1) in accordance with claim 7, in which the temporary storage system (8) for rolled products is designed as a belt conveyor (4).
